(19) United States
(12) Patent Application Publication
(10) Pub. No.: US 2025/0250459 A1
(43) Pub. Date: Aug. 7, 2025

(54) MULTI-LAYER SURFACE PROTECITON FILMS AND METHODS FOR MAKING THE SAME

(71) Applicant: DelStar Technologies, Inc., Alpharetta, GA (US)

(72) Inventors: Dave Collette, South Hadley, MA (US); Jeffrey Pratt, Orange, MA (US)

(21) Appl. No.: 18/429,776

(22) Filed: Feb. 1, 2024

Related U.S. Application Data
(60) Provisional application No. 63/482,859, filed on Feb. 2, 2023.

(51) Int. Cl. C09D 175/04; C08J 7/046; C09D 5/00

(52) U.S. Cl. CPC C09D 175/04; C08J 7/046; C09D 5/00

(57) ABSTRACT

Multi-layer surface protection films and methods for making and using such films are provided. The surface protection films have first and second thermoplastic polyurethane (TPU) layers and an intermediate ethylene vinyl acetate (EVA) layer positioned between the first and second TPU layers. The use of first and second TPU layers as outer layers aids in the optical clarity of the film. The TPU layers may have different thicknesses. The use of EVA as a component of the film layers provides a lower cost film, as compared to conventional monolayer TPU films. The EVA component properties and overall ratio of EVA in the film can be used to modify physical properties of the multi-layer structure, while maintaining equivalent or superior performance to these films when used as a coating for surfaces on a wide range of applications, such as automobiles, wind turbine blades, appliances, electronic displays, mobile devices, and the like.

### CROSS-REFERENCE TO RELATED APPLICATIONS

This application claims the benefit of U.S. Provisional Application Ser. No. 63/482,859, filed Feb. 2, 2023, the complete disclosure of which is incorporated herein by reference for all purposes.

### TECHNICAL FIELD

This description generally relates to films and more particularly to multi-layer films for use in protecting exterior surfaces.

### BACKGROUND

Films and laminates having high optical transparency to visible light are desirable in several applications. For example, films having high optical transparency are used in vehicle windshields and sunroofs, food packaging, optical disk devices, residential and commercial windows, and the like.

Surface protection films provide a shield for bare or painted surfaces, such as metal, glass, and plastic, that are exposed to extreme conditions to aid in preventing damage from abrasion, chipping, chemicals, and mechanical and environmental wear. Desirable characteristics of such surface protection films include optical clarity, a high gloss surface, high and low temperature flexibility, conformability to three-dimensional surfaces, abrasion, and impact resistance. In addition, it is desirable that the films are easy to install and are cost-effective.

Although surface protection films with such characteristics are known, the optical and gloss features of these films can be compromised in downstream coating and handling processes. In addition, temperature, pressure, wind tension, and contact with other surfaces can negatively impact these characteristics.

Thermoplastic polyurethane (TPU) surface protection films are commercially available. TPU surface protection films are typically a two-layer structure having a carrier layer (e.g., polyethylene terephthalate (PET)) and a TPU layer. In recent years, commercial TPU has become increasingly expensive. Cost-effective alternatives to TPU surface protection films have been investigated. However, such films have one or more disadvantages including an undesirable level of conformability/flexibility, poor optical clarity, gloss, and abrasion and impact resistance. In addition, many of these alternatives contain halogen, which can cause unwanted corrosion of metal surfaces.

Therefore, it would be advantageous to develop a cost-efficient film with the above-described characteristics for surface protection. It would be further advantageous if the cost-efficient film is easy to use, environmentally friendly, and compatible with commercial adhesive systems.

### SUMMARY

The following presents a simplified summary of the claimed subject matter to provide a basic understanding of some aspects of the claimed subject matter. This summary is not an extensive overview of the claimed subject matter. It is intended to neither identify critical elements of the claimed subject matter nor delineate the scope of the claimed subject matter. Its sole purpose is to present some concepts of the claimed subject matter in a simplified form as a prelude to the more detailed description that is presented later.

Surface protection films and methods for manufacturing and using such films are provided herein. In a first aspect, a film comprises first and second thermoplastic polyurethane (TPU) layers and an ethylene vinyl acetate (EVA) layer positioned between the first and second thermoplastic polyurethane layers.

The films are less costly to manufacture than conventional monolayer TPU films, while maintaining equivalent or superior performance to these films when used as a coating for surfaces on a wide range of applications, such as automobiles, wind turbine blades, appliances, electronic displays, mobile devices, and the like. The surface protection films described herein are easy to use, compatible with commercial adhesive systems and environmentally friendly, i.e., they comprise non-PVC, halogen- and lubricant-free materials. In addition, the physical properties (stiffness/resiliency) of the multi-layer surface protection films described herein can be modified by the EVA layer grade to tailor the finished product to installer's preference, such as stiffer or softer stretch. Further, the surface protection films have excellent abrasion and impact resistance to provide users with a durable layer of protection for cars, trucks, appliances, mobile devices, computers, and electronic display screens and the like.

In various embodiments, the first and second thermoplastic layers have a different thickness. In another embodiment, the thickness of the first thermoplastic layer is less than the thickness of the second thermoplastic layer, and the thickness of the intermediate EVA layer is greater than the first thermoplastic layers, and greater than or equal to the thickness of the second thermoplastic layer.

In various embodiments, the EVA layer is about 20% to about 70% of the total thickness of the film, or about 20% to about 55% or less. In an exemplary embodiment, the thickness of the EVA layer 106a is about 30% to about 35% of the total thickness of the film or about 33% of the total thickness of the film.

In various embodiments, the EVA layer comprises a thermoplastic EVA co-polymer composition which is based on a medium proportion of vinyl acetate (VA) in the EVA co-polymer, such as below about 40%. In one embodiment, the EVA copolymer comprises between about 10% to about 40%, and in another embodiment, the EVA copolymer comprises a proportion of VA in the EVA copolymer of between about 28% to about 33%.

In various embodiments, the TPU layers comprise an aliphatic thermoplastic polyurethane (ATPU), and the composition of each thermoplastic layer may be the same or different.

In various embodiments, the surface protection film has a carrier layer positioned on a surface of one of the thermoplastic layers. In one embodiment, the carrier layer is PET.

In various embodiments, the surface protection film has a pressure sensitive adhesive (PSA) affixed to an outer surface of the surface protection film. According to one embodiment, the PSA coated surface protection film has a pressure sensitive adhesive (PSA) layer which is adhered to the first TPU layer. An EVA layer is positioned on top of the first TPU layer, and a second TPU layer is positioned on top of the intermediate EVA layer. Optionally, a carrier layer is positioned on the second TPU layer. Also optionally, a release layer is positioned on the outer surface of the PSA layer.

In another aspect, a window is provided comprising any of the films described above. In another aspect, an exterior part for a vehicle is provided comprising any of the films described above. In another aspect, a wind turbine blade is provided comprising any of the films described above. In yet another aspect, an electronic display is provided comprising any of the films described above.

In another aspect, a protective coating for a surface comprises first and second thermoplastic polyurethane layers and an ethylene vinyl acetate layer positioned between the first and second thermoplastic polyurethane layers. The protective coating has a 5% secant modulus less than about 5000 psi or less than about 3600 psi, or less than about 2200 psi. The secant modulus is the measure of the initial stiffness of the material. Thus, the EVA layer provides a more elastic coating that is easier to install.

In various embodiments, the coating has a chipping rating of 8.5 A as measured by a gravelometer according to ASTM D3170. Thus, the coating has a lower cost compared to a single layer TPU film while maintaining equivalent performance in chip resistance as measured by gravelometer testing.

In various embodiments, the coating has an ultimate elongation MD of about 450% to about 550% or about 500%.

In various embodiments, the coating has a light transmission of at least about 93%.

In another aspect, a method of making a surface protective film is provided. The method comprises providing an extrusion assembly for co-extrusion of a three-layer film. A carrier layer, first and second polymer resins comprising a TPU, and an EVA resin comprising a thermoplastic EVA copolymer is also provided. The first and second polymer resins and the EVA resin are co-extruded onto the carrier layer through the extrusion assembly to form the surface protection film having first and second TPU layers as outer layers and an intermediate EVA layer positioned in between the first and second TPU layers.

In various embodiments, the surface protective film has asymmetric layers, where one or more of the first and second TPU layers and the intermediate EVA layer is of a different thickness than another layer. In one embodiment, the thickest TPU layer is co-extruded adjacent to the carrier layer. In one embodiment, the thickest thermoplastic layer is co-extruded adjacent to the carrier layer.

The recitation herein of desirable objects which are met by various embodiments of the present description is not meant to imply or suggest that any or all these objects are present as essential features, either individually or collectively, in the most general embodiment of the present description or any of its more specific embodiments.

### BRIEF DESCRIPTION OF THE DRAWINGS

FIG. 1A is a side-view of a multi-layer surface protection film;

FIG. 1B is a side-view of another embodiment of a multi-layer surface protection film;

FIG. 1C is a side-view of another embodiment of a multi-layer surface protection film;

FIG. 2A is a side-view another embodiment of a multi-layer surface protection film having a PSA layer and a liner;

FIG. 2B is a side-view illustration of a surface coated with a multi-layer surface protection film, according to another embodiment;

FIG. 3A is a graph showing a 5% secant modulus for the multi-layer surface protection films described herein;

FIG. 3B is a graph showing ultraviolet (UV) blocking of the multi-layer surface protection films described herein;

FIG. 4 is a graph showing UV blocking of the multi-layer surface protection films described herein;

FIGS. 5A and 5B are graphs showing the results of accelerated aging of the multi-layer surface protection films described herein in comparison to a TPU film;

FIGS. 6A and 6B are graphs showing hysteresis testing of a TPU/PVDF-PMMA (polyvinylidene fluoride (PVDF)-polymethyl methacrylate (PMMA) blend) film, and a 2-layer TPU film, respectively, provided as comparative examples; and

FIG. 7 is a graph showing hysteresis testing of the multi-layer surface protection films described herein;

### DETAILED DESCRIPTION OF THE EMBODIMENTS

This description and the accompanying drawings illustrate exemplary embodiments and should not be taken as limiting, with the claims defining the scope of the present description, including equivalents. Various mechanical, compositional, structural, and operational changes may be made without departing from the scope of this description and the claims, including equivalents. In some instances, well-known structures and techniques have not been shown or described in detail so as not to obscure the description. Like numbers in two or more figures represent the same or similar elements. Furthermore, elements and their associated aspects that are described in detail with reference to one embodiment may, whenever practical, be included in other embodiments in which they are not specifically shown or described. For example, if an element is described in detail with reference to one embodiment and is not described with reference to a second embodiment, the element may nevertheless be claimed as included in the second embodiment. Moreover, the depictions herein are for illustrative purposes only and do not necessarily reflect the actual shape, size, or dimensions of the system or illustrated components.

It is noted that, as used in this specification and the appended claims, the singular forms “a,” “an,” and “the,” and any singular use of any word, include plural referents unless expressly and unequivocally limited to one referent. As used herein, the term “include” and its grammatical variants are intended to be non-limiting, such that recitation of items in a list is not to the exclusion of other like items that can be substituted or added to the listed items.

Except as otherwise noted, any quantitative values are approximate whether the word “about” or “approximately” or the like are stated or not. The materials, methods, and examples described herein are illustrative only and not intended to be limiting.

Multi-layer surface protection films and methods for manufacturing and using such films are provided herein. The surface protection films have first and second thermoplastic polyurethane (TPU) layers and an intermediate ethylene vinyl acetate (EVA) layer positioned between the first and second TPU layers. The use of EVA as a component of the film layers provides a lower cost film (as compared to a monolayer TPU film) while maintaining equivalent performance in gravelometer testing. For example, at current market rates, EVA resin has a commercial price of about $6.30 USD/lb less than virgin TPU. This cost savings translates to about a $0.50 USD/linear foot savings for a 6 mil surface protection film having an approximate 2 mil EVA layer, with the balance of the layers being virgin TPU.

The physical properties (stiffness/resiliency) of the multi-layer surface protection films described herein can be modified by the EVA layer grade to tailor the finished product to installer's preference, such as stiffer or softer stretch. In addition, the surface protection films described herein are easy to use, compatible with commercial adhesive systems and environmentally friendly, i.e., they comprise non-PVC, halogen- and lubricant-free materials. Further, the surface protection films have excellent abrasion and impact resistance to provide users with a durable layer of protection for cars, trucks, appliances, mobile devices, computers, and electronic display screens, for example.

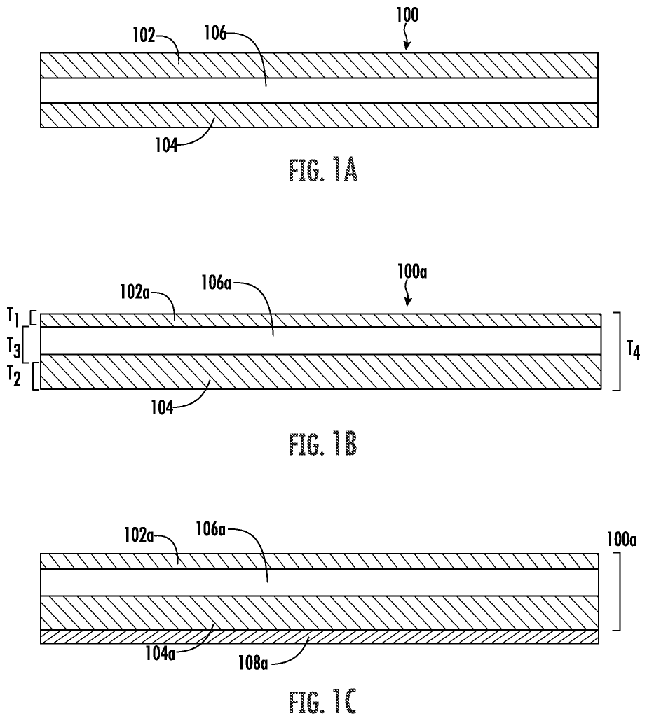

Referring now to FIG. 1A, a surface protection film 100 comprises a first TPU layer 102 and second TPU layer 104. An intermediate EVA layer 106 is positioned in between the first and second TPU layers 102, 104. In some embodiments, the layers 102, 104, and 106 are positioned on each other, as described herein, without the use of an intermediate adhesive layer. In one embodiment, the layers 102, 104, and 106 are compatible for co-extrusion and are affixed without an adhesive layer by co-extrusion of the layers. In this embodiment, the thickness of layers 102, 104 and 106 are substantially the same.

Referring to FIG. 1B, another embodiment of a surface protection film 100a comprises a first TPU layer 102a, second TPU layer 104a and an intermediate EVA layer 106a positioned therebetween. First TPU layer 102a has a thickness (T₁), second TPU layer 104a has a thickness (T₂), intermediate EVA layer 106a has a thickness (T₃), and surface protection film 100a has an overall thickness (T₄) which includes the thickness of the two TPU layers 102a, 104a and the EVA layer 106a, such that T₄=T₁+T₂+T₃. In this embodiment, surface protection film 100a, the first and second TPU layers 102a, 104a are asymmetric, e.g., having a different thickness. As shown, the thickness T₁ of first TPU layer 102a is less than the thickness T₂ of second TPU layer 104a, such that T₁<T₂. In some embodiments, the thickness T₃ of EVA layer 106a is greater than one or both first and second TPU layers T₁ and T₂, each individually. In other embodiments T₂ is greater than T₃ which is greater than T₁, such that T₂>T₃>T₁. In some embodiments, the thickness T₃ of intermediate EVA layer 106a is within the range of about 20% to about 70% of the total thickness T₄ of the film 100a, and in some embodiments, about 20% to about 55% or less. In some embodiments, the thickness T₃ of the intermediate EVA layer 106a is within the range of about 30% to about 35% of the total thickness T₄ of the film 100a. In one embodiment, the thickness T₃ of the intermediate EVA layer 106a comprises about a third (33%) of the total thickness T₄ of the film 100a.

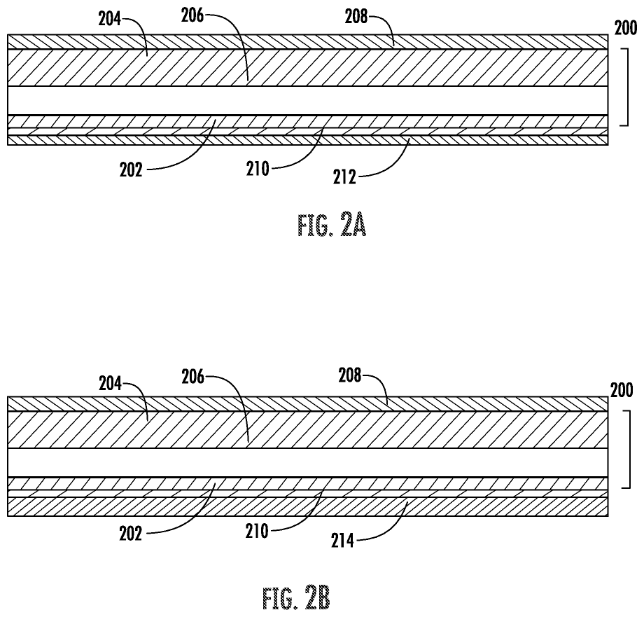

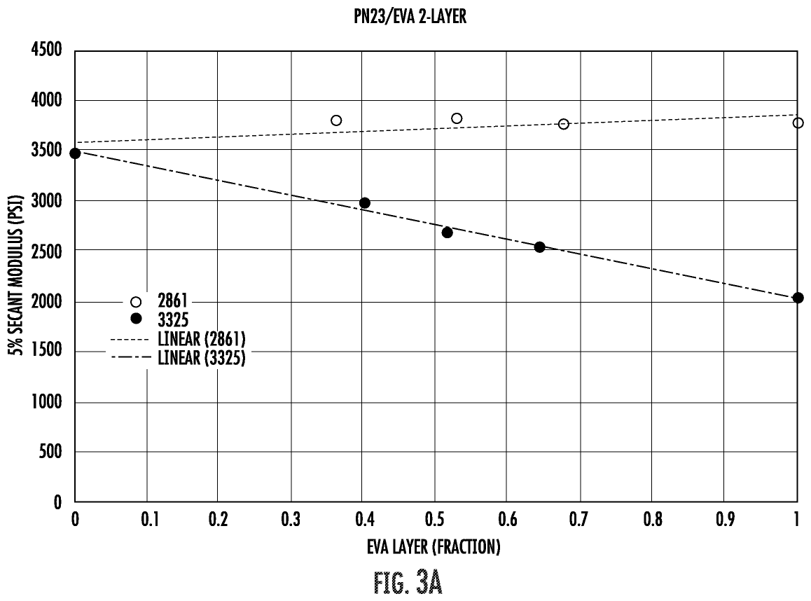

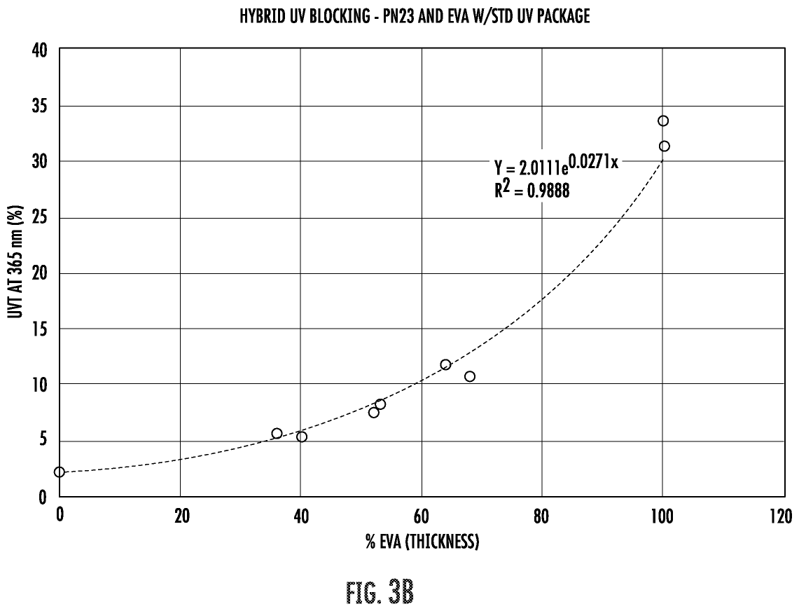

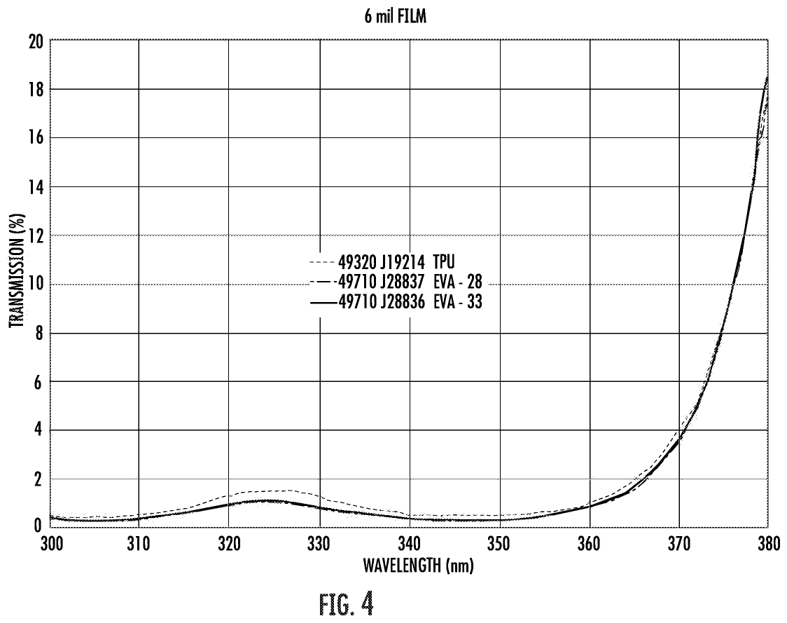

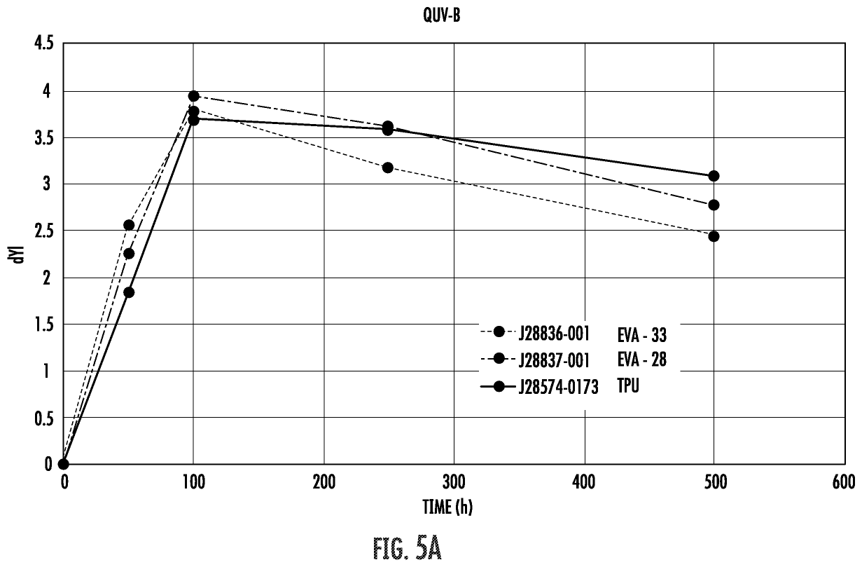

In some embodiments, the surface protection film 100s has a total thickness T₄ of about 6 mil. In one embodiment, the intermediate EVA layer 106a has a thickness T₃ of between about 2 mil to 4 mil, and in another embodiment the intermediate EVA layer 106a has a thickness T₃ of about 2 mil. In another embodiment, the first thermoplastic layer 102a has a thickness T₁ of about 1 mil, and the second thermoplastic layer 104a has a thickness T₂ of between about 1 mil to about 3 mil. In another embodiment, the first thermoplastic layer 102a has a thickness T₁ of about 1 mil, the second thermoplastic layer 104a has a thickness T₂ of about 3 mil, and the intermediate EVA layer 106a has a thickness of about 2 mil. Although the thickness of the thermoplastic layers 102a, 104a and intermediate EVA layer 106a are shown in FIGS. 2B and 3A-C and described in some embodiments as T₂>T₃>T₁, other embodiments are within the scope of the description.

The intermediate EVA layer comprises an EVA copolymer composition, also referred to as an EVA copolymer resin, formed from the co-polymerization of ethylene and vinyl acetate. The copolymer of ethylene and vinyl acetate may be copolymerized with other resins, such as low density polyethylene (LDPE), and or contain other polymers or polymer blends and additives to enhance the features such as clarity, hardness, flexibility, toughness, etc., which are desired in the surface protective film. The properties of the surface protection film can be altered by varying the EVA component properties, e.g., varying the VA content of the EVA copolymer. For example, a lower percentage of VA in the EVA copolymer produces a stiffer film. Properties of the multi-layer surface protection film can also be modified by the overall thickness of the EVA layer. The EVA component properties, as well as the thickness of the EVA layer can be used to tailor the finished product to an installer's preference, such as stiffer or softer stretch.

In some embodiments, the intermediate EVA layer comprises a thermoplastic EVA co-polymer composition which is based on a medium proportion of VA in the EVA co-polymer resin of less than about 40%, and between about 10% to about 40%. In one embodiment, the EVA copolymer is an extrudable polymer comprising a proportion of VA in the EVA copolymer resin of between about 28% to about 33%. The EVA co-polymer may contain other additives, stabilizers, such as a UV stabilizer, adhesion promoters, co-polymers, cross-linkers, and polymer blends to enhance performance of the film.

EVA co-polymer resins are commercially available. Examples of suitable EVA copolymer resins include ATEVA-2861A (EVA-28), and ATEVA-3325A (EVA-33), available from Celanese EVA Performance Polymers LLC, 4405-101 Ave. NW, Edmonton, AB T6A 0L2, Canada. TABLE 1 shows exemplary and resin properties, thermal properties, and molded plaque properties of EVA copolymer resins suitable for use in the surface protection film described herein, as well as the typical properties of EVA-28 and EVA-33.

TABLE 1
EVA Resin Properties

| | | EVA-28/ | | |
|---|---|---|---|---|
| EVA Resin Properties | Exemplary | EVA-33 | SI Unit | Test Method |
| Vinyl Acetate | 20-40 | 28/33 | % | PTM-39 |
| Melt Index | 6-43 | 6/43 | g/10 min. | ASTM D1238 |
| (190° C./2.16 kg) | | | | |
| Density | 949-952 | 949/952 | kg/m³ | ASTM D1505/ |
| | | | | ASTM D1928 Proc A |
| Antioxidant | Yes | Yes | | |
| DSC Melt Temp | 60-71 | 71/60 | C. | ASTM D3418 |
| Ring & Ball Softening Point | 113 | 113 | C. | ASTM E28 |
| Vicat Softening Point | 43 | 43/NA | C. | ASTM D1525 |
| Tensile Strength at Break | 9-14 | 14/9 | MPa | ASTM D638 |
| Elongation at Break | 760-900 | 760/900 | % | ASTM D2240 |
| Hardness - Shore A | 68 | NA/68 | — | ASTM D2240 |
| Hardness - Shore D | 16-27 | 27/16 | — | ASTM D2240 |
| Flexural Modulus | 7 | NA/7 | MPa | ASTM D790 |
| (1% Secant) | | | | |

The first and second thermoplastic polymer layers comprise a TPU resin. The TPU resin is produced by the polyaddition reaction between a diisocyanate and one or more polyols or long-chain diols, a chain extender or short-chain diol, and a diisocyanate. The TPU is a linear segmented block copolymer composed of hard and soft segments. The soft segment may be a polyether, polyester, or polycaprolactone, which provides flexibility and elastomeric character of the TPU. The hard segment (aromatic or aliphatic) is constructed from a chain extender and isocyanate. In some embodiments, the hard segment is based on an aliphatic isocyanate. In one embodiment, the TPU resin comprises an ATPU. The first and second TPU layers 102, 104 may be comprised of the same or different TPU resin. The use of different TPU resins in the first and second thermoplastic layers 102, 104 can confer different properties and provide different advantages. For example, one layer may confer high gloss and stain resistance, while another layer may confer chip resistance. Other additives, stabilizers, such as a UV stabilizer, adhesion promoters, co-polymers, cross-linkers, and polymer blends may be included in the TPU resin to enhance performance of the film.

TPU compounds are commercially available. The ATPU resin may be an extrudable, UV stabilized weatherable grade such as those commercially available used to make paint protective films. Examples of suitable ATPU include KRYSTALGRAN® PN23-200, an aliphatic polycaprolactone-based TPU, available from Huntsman Corporation, The Woodlands, TX, U.S.A; MIRATHANE® A290, an aliphatic polyester-based TPU, Miracll Chemicals Co., Ltd., Yantai, Shandong, PRC; ELASTANE® ALR CLC93A-V, The Lubrizol Corporation, Wickliffe, OH, U.S.A; and the ELASTOLLANE® L Series 785 A10, an aliphatic ester-based TPU from BASF, Florham Park, NJ, U.S.A.

TABLE 2 shows exemplary TPU properties usable in the surface protection film 100.

TABLE 2
TPU Resin Properties

| TPU Properties | Exemplary | SI Unit | Test Method |
|---|---|---|---|
| Hardness - Shore A | 86-90 | — | ASTM D2240/ |
| | | | DIN ISO 48-4 (3s) |
| Hardness - Shore D | 43 | — | ASTM D2240 |
| Density | 1.13-1.16 | g/cm³ | ASTM D792 |
| Vicat Softening Point | 59 | C. | ASTM D1525 |
| Tensile Strength | 25-55 | MPa | ASTM D 412 |
| Elongation at Break | 400-500 | % | DIN 53504-S2 |
| Stress at 20% Elongation | 2 | MPa | DIN 53504-S2 |
| Stress at 100% Elongation | 8.5/4-6 | MPa | ASTM D 412/ |
| | | | DIN 53504-S2 |
| Stress at 300% Elongation | 29.4/10-15 | MPa | ASTM D 412/ |
| | | | DIN 53504-S2 |
| Tear Strength | 80.5/10-85 | kN/M | ASTM D 624/ |
| | | | DIN 53504-S2 |
| Flexural Modulus | 22.7 | MPa | ASTM D790 |
| Abrasion | 56 | mm³ | ISO 4649 |

Weathering Resistance

| | | | |
|---|---|---|---|
| ΔE (QUV, 1000 h, 340 nm) | <3 | — | ASTM D 4329 |

Referring now to FIG. 1C, in some embodiments, the surface protection film 100a further comprises a carrier layer 108 in contact with an outer surface of one of the TPU layers. In one such embodiment, carrier layer 108 is adhered to the outer surface of second TPU layer 104a. In an exemplary embodiment, the carrier layer comprises PET.

In some embodiments, surface protection films 100, 100a according to the description have properties as shown in TABLE 3. The tuning parameters are the starting properties of the two pure components (ATPU and EVA) and the relative thicknesses of each. In some embodiments, the ATPU and EVA resins in the film 100 have compatible viscosities at similar temperatures.

TABLE 3
Film Properties for TPU/EVA/TPU Surface Protection Film.

| | | Embodiments | | |
|---|---|---|---|---|
| Film Properties | Appx. | Range or | | |
| 6 mil TPU/EVA/TPU | Value | Appx. Value | Units | Test Method |
| EVA Thickness (T₃) | 33 | 20-70 | (%) | Internal TM (Nikon AZ100 |
| | | | | Optical Microscope) |
| Color - Initial YI | <1 | <.85; <.63 | | Internal TM (BYK-Gardner |
| | | | | Spectro-Guide Sphere) |
| UVT @ 365 nm (%) | <2.2 | <1.8-2.2 | (%) | Internal TM (Agilent |
| | | | | Cary 60 UV-Vis) |
| Gloss (60 Degree) | ≥90 | ≥90; ≥94 | (%) | Internal TM (BYK-Gardner |
| | | | | Gloss Meter) |
| Haze (%) | <3 | | (%) | ASTM D1003 |
| Light Transmission (%) | >90 | 93 | (%) | ASTM D1003 |
| Peel Force | 10-60 | 16 | (gli) | Internal TM (TMI Lab Master |
| | | | | Model 80-91 135°/300 ipm |
| Ultimate Tensile - MD | >7000 | >7200 | (psi) | ASTM D882 |
| Ultimate Tensile - TD | >7000 | >7150 | (psi) | ASTM D882 |
| Ultimate Elongation-MD | >450 | >500 | (%) | ASTM D882 |
| Ultimate Tensile - TD | >450 | ≥490 | (%) | ASTM D882 |
| Modulus at 100% - MD | 1500 ± 500 | 1300-1340 | (psi) | ASTM D882 |
| Modulus at 100% - TD | 1500 ± 500 | 1270-1325 | (psi) | ASTM D882 |
| Modulus at 50% - MD | ~1000 | 930-970 | (psi) | ASTM D882 |
| Modulus at 50% - TD | ~1000 | 920-950 | (psi) | ASTM D882 |
| Secant Modulus 5% -MD | <5000 | 3240-3550 | (psi) | Internal TM (Instron Tensile |
| | | | | Tester: 5″ initial jaw |
| | | | | separation, 0.5 in/min) |
| Secant Modulus 5% -TD | <5000 | 3240-3550 | (psi) | Internal TM (Instron Tensile |
| | | | | Tester: 5″ initial jaw |
| | | | | separation, 0.5 in/min) |
| Interlayer Adhesion | 5B | 5B | | ASTM D3369 |
| Gravelometer | ~8 B | 8.5 A | | ASTM D3170 |
| Dimensional Stability-MD | 0 ± 1 | −1.25 | (%) | Internal TM (60°/30 min) |
| Dimensional Stability-TD | 0 ± 1 | −0.7-−0.85 | (%) | Internal TM (60°/30 min) |

In one embodiment, film 100 has an ultimate tensile strength of greater than about 7000, as measured by ASTM D882. Film 100 has a 5% Secant Modulus-MD of <about 5000 psi, and in other embodiments, the surface protection film 100 has a 5% Secant Modulus-MD of about 3240 psi to less than about 3550 psi. The secant modulus was calculated using two points on a stress-strain curve to calculate the slope of the stress/strain, with the first point at zero and the second the stress/strain at 5%. For example, for a secant modulus calculated at 5% tensile strain, the formula for the calculation is: Secant Modulus=(σ2−σ1)/(ε2−ε1)=(Stress @ 2% Strain−0)/(2% Strain−0).

The secant modulus is representative of how easily the film can be installed. Secant modulus is one of several methods used to calculate modulus of elasticity, which is a measurement of a material's elasticity. In some embodiments, the film 100 exhibits lower force at low elongation, as shown in TABLE 3. In an exemplary embodiment, film 100 has an ultimate elongation of greater than about 450, or greater than about 500 MD as measured by ASTM D882.

Referring now to FIG. 2A, in some embodiments, a surface protection film 200 has a PSA affixed to the surface protection film 200. In one such embodiment, the PSA coated surface protection film 200 has a PSA layer 210 in contact with the outer surface of one of the TPU layers, preferably adhered to the outer surface of first TPU layer 202. The intermediate EVA layer 206 is positioned on first TPU layer 202, and second TPU layer 204 is positioned on the intermediate EVA layer 206. In some embodiments, a carrier layer 208 is positioned on second TPU layer 206. Also in some embodiments, the surface protection film 200 with PSA layer 210 has a release layer 212, also referred to as a release liner, positioned on an outer surface of the PSA layer 210.

Referring now to FIG. 2B, a surface 214 having a surface protection film 200 affixed thereto is shown. According to some embodiments, the surface has a PSA layer 210 adhered to the surface 214, the first TPU layer 202 is adhered to the PSA layer 210. The intermediate EVA layer 206 is positioned on the first TPU layer 202, and the second TPU layer 104 is positioned on the intermediate EVA layer 206. In some embodiments, a carrier layer 208 is positioned on the second TPU layer 206. In some embodiments, the carrier 208 may comprises a dual surface film that has a rough, matte surface on one side and a glossy, smooth surface on the other side, combining differential surface roughness with high strength and durability, good dimensional stability, and chemical resistance. An example of a suitable carrier layer film 208 is a PET carrier. An example of a commercially available carrier film is Hostaphan® MT44, Mitsubishi Chemical America, Inc.

The surface protection film 200 can be applied to a variety of painted or bare surfaces, also referred to as substrates, and can be cut to the dimension of various surfaces. Examples of surfaces suitable for application of the surface protection film are vehicle bodies, windows, and aerospace vehicles, as well as a variety of other consumer goods, such as electronic screens and sporting goods, to protect the goods from wear. In one embodiment, the surface is a painted surface, and in some embodiments, the painted surface is an automobile.

A method of making a surface protective film according to the description is provided. First, a carrier layer 108 is provided, such as PET Carrier MT44, Mitsubishi. A 3-Layer Coextrusion feedblock was used to extrude a multi-layer structure consisting of TPU in the two outer layers and EVA in the center layer. The layers were positioned to put thickest TPU layer, such that the thickest outer layer is formed adjacent to the carrier layer. Three coextruded layers of TPU/EVA/TPU are then passed through a suitable extrusion die onto the carrier layer 108.

Although the method of making the layers of the film 100 are described as being formed by extrusion, other methods known in the art can be used, such as calendaring and solvent casting. For example, the layers may be extruded sequentially, or two of the layers may be co-extruded, followed by sequential extrusion of the third layer. The film layers may be extruded using a multi-manifold coextrusion die or a coextrusion feedblock approach. The methods may also include laminating the multilayer film to one or more adhesive layers such that the one or more of the layers are “sandwiched” between an adhesive layer. Adhesives may include acrylics, polyurethanes, silicones, styrene-butadiene block copolymers, styrene-isoprene block copolymers, epoxies, cyanosacrylates, etc. In one embodiment, the adhesive may be a PSA. In other embodiments, one or more layers is solvent cast, which can be combined with subsequent co-extrusion or sequential extrusion of additional layers. For example, the carrier layer 108 may be solvent cast onto a liner and the film 100 layers may be subsequently extruded onto the carrier layer 108.

In some embodiments, an adhesive layer 110 is affixed on a top surface of the surface protection film 100. In one embodiment, a surface protective film 100 is provided, optionally with a carrier layer 108, and an adhesive, such as a PSA layer 110 affixed to a release liner 112 is adhered to the surface protection film 100. In some embodiments, the release liner 112 is removed and the PSA 110 is affixed to the surface protection film, which is subsequently affixed a surface or substrate 114. In some embodiments, the PSA 110 and accompanying surface protection film 100 are affixed to the surface 114 without the use of heat.

### EXAMPLES

### General Procedures:

Coextrusion of multiple thermoplastic melt streams may be done using multiple techniques known in the art. Ultimately, the independent layers of material are brought together at or before the point of extrusion. This may be done using a variety of commercially available “feedblock” configurations that orient the multiple layers as desired in the final construction prior to introduction to the extrusion die. Coextrusion may also be accomplished using a multi-manifold die which brings the layers together right at the point of extrusion, allowing more flexibility for layers with different processing temperatures compared with the feedblock approach.

### Example 1. Two-Layer TPU/EVA Surface Protection Film

Two layer surface protection films were prepared using KRYSTALGRAN® PN23-200, Huntsman Corporation as a TPU layer, and ATEVA-2861A (EVA-28) and ATEVA-3325A (EVA-33), Celanese EVA Performance Polymers LLC, as a second EVA layer. Single layer TPU, EVA-28 and EVA-33 were prepared as indicated in TABLE 4 below as comparative examples. The two-layer surface protection films were extruded onto a liner using two mono layer extrusions. The first layer of TPU was applied to the carrier layer, with the EVA layer being extruded as a separate layer onto the TPU surface of the carrier layer/TPU structure.

TABLE 4
Two-Layer TPU/EVA Samples
Test Films

| | | | | | Gauge |
|---|---|---|---|---|---|
| Sample | Gauge #1 | Resin #1 | Gauge #2 | Resin #2 | total |
| 1 | 6 | TPU | — | — | 6 |
| 2 | — | — | 6 | EVA-28 w/UV | 6 |
| 3 | 2 | TPU | 4 | EVA-28 w/UV | 6 |
| 4 | 3 | TPU | 3 | EVA-28 w/UV | 6 |
| 5 | 4 | TPU | 2 | EVA-28 w/UV | 6 |
| 6 | — | — | 6 | EVA-33 w/UV | 6 |
| 7 | 2 | TPU | 4 | EVA-33 w/UV | 6 |
| 8 | 3 | TPU | 3 | EVA-33 w/UV | 6 |
| 9 | 4 | TPU | 2 | EVA-33 w/UV | 6 |

Samples 1-9 were evaluated as shown below in Table 5. All films were found to have an acceptable 5% Secant, as shown in Table 5 and FIG. 3A, and acceptable elongation, as shown in Table 5. Two-layer EVA-28-TPU films having acceptable tensile strength were found to have less than about a 53% microscopic EVA layer thickness of EVA-28 (2.2-3.2 mil EVA layer with the balance TPU), as shown in Table 5. Two-layer EVA-33-TPU films having acceptable tensile strength were found to have less than about a 40% microscopic EVA layer thickness of EVA-33, as shown in Table 5. All films were shown to have acceptable UV blocking with standard UV additives, as shown in FIG. 3B. However, all EVA-TPU two-layer films were found to have unacceptable optical qualities, e.g., haze.

TABLE 5
Mechanical Properties of Samples 1-9

| Microscopic EVA | | | | | | | | |
|---|---|---|---|---|---|---|---|---|
| Layer Thickness | | | Mechanical Properties | | | | | |
| Mils | | | Tensile | Elongation | 100% Tensile | 50% Tensile | 5% Secant | UVT |
| 1 | 0 | 0 | 10816 | 545 | 1658 | 1128 | 3484 | 2.2 |
| 2 | 100% | 6 | 2542 | 578 | 879 | 737 | 3785 | 31.4 |
| 3 | 68% | 4.1 | 6043 | 528 | 1313 | 791 | 3765 | 10.8 |
| 4 | 53% | 3.2 | 7451 | 533 | 1550 | 1116 | 3825 | 8.3 |
| 5 | 36% | 2.2 | 8715 | 546 | 1718 | 1218 | 3811 | 5.7 |
| 6 | 100% | 6 | 1699 | 888 | 409 | 382 | 2034 | 33.6 |
| 7 | 64% | 3.9 | 5242 | 539 | 934 | 696 | 2545 | 11.8 |
| 8 | 52% | 3.1 | 6621 | 539 | 1099 | 789 | 2704 | 7.6 |
| 9 | 40% | 2.4 | 7480 | 558 | 1231 | 869 | 2981 | 5.5 |

| | | | | | | |
|---|---|---|---|---|---|---|
| Requirement | >7000 | >450 | 1500 +/− 500 | NA | <5000 | <1.5 |

### Example 2. Three-Layer TPU/EVA/EVA Surface Protection Film

Three-layer TPU/EVA/EVA prototype samples (6 mil total thickness) were prepared using ELASTANE® ALR CLC93A-V2, The Lubrizol Corporation as the TPU layer (4 mil thickness), a layer of ATEVA-3325A (EVA-33), with and without Fusabond C25 as a middle layer (0.5 mil thickness), and ATEVA-3325A (EVA-33) Celanese EVA Performance Polymers LLC (1.5 mil thickness) as a top layer. The TPU and EVA Resin compositions were extruded onto a PET carrier layer, MT44, Mitsubishi (0.002″×68″). For the three-layer TPU/EVA/EVA examples, a 3-layer coextrusion feedblock was used to extrude a multi-layer structure having TPU as the outer layer and EVA as the center layer and outer layers. The feedblock was configured such that the TPU layer was formed adjacent to the carrier layer. The three coextruded layers of TPU/EVA/EVA were then passed through an extrusion die onto the carrier layer. The samples were prepared with the EVA and TPU percent compositions shown in TABLE 6 and the properties of the sample films were evaluated as shown in TABLE 6. The tests marked with an asterisk (*) were conducted with the film only. The tests marked with a double asterisk (**) were conducted with wet laminated exposed/EVA side to ⅛″ clear glass. The tests marked with a triple asterisk (***) were conducted with Tesa SP PSA; dry laminated to exposed/EVA side, 24 hour dwell; 180 deg peel at 2″/min and High UVT at 365 nm due to CLC-93A-V2 resin. The tensile, elongation, modulus and secant modulus tests were conducted according to ASTM D-882. The interlayer adhesion testing was conducted according to ASTM D3359 (TPU side/EVA side). The dimensional stability tests were at 60 C/30 min.

TABLE 6

| | J27367-01 | J27367-02 | J27367-03 | J27367-04 | J27367-05 | J27367-06 | Control |
|---|---|---|---|---|---|---|---|
| EVA % (Thickness) | 25 | 33 | 33 | 50 | 58 | 33 | 0 |
| Target | | | | | | | |
| EVA % (Thickness) | 23 | 28 | 30 | 45 | 55 | 36 | 0 |
| Actual | | | | | | | |
| Color - Initial YI | .3 | 3 | .3 | .4 | .4 | 5 | .5 |
| UVT at 365 nm (%) | 77 | 75.8 | 76t | 76.8 | 78 | 74.6 | |
| UVT at 330 nm (%) | 3.3 | 5.4 | 5.7 | 6 | 10.3 | 5 | |
| Gloss (60 degree) | 92 | 92 | 92 | 92 | 92 | 92 | 92 |
| Haze (%)* | 25 | 28 | 29 | 29 | 29 | 33 | 1.5 |
| Haze (%)** | 0.8 | 0.5 | 0.8 | 0.6 | 1 | 0.6 | 0.7 |
| Light Transmission | 93 | 94 | 93 | 95 | 94 | 93 | 95 |
| (%)* | | | | | | | |
| Light Transmission | 91 | 91 | 91 | 91 | 91 | 91 | 91 |
| (%)** | | | | | | | |
| Peel Force (g/in) | | | | | 15 | | 25 |
| Ultimate Tensile: | 9025 | 8029 | 7209 | 6875 | 5539 | 8010 | 10540 |
| MD (psi) | | | | | | | |
| Ultimate Elongation: | 511 | 496 | 494 | 478 | 476 | 500 | 508 |
| MD (%) | | | | | | | |
| Modulus at 100% | 1200 | 1102 | 1026 | 1030 | 880 | 1122 | 1342 |
| MD (psi) | | | | | | | |
| Modulus at 50% MD | 819 | 760 | 722 | 724 | 644 | 781 | 871 |
| (psi) | | | | | | | |
| 5% Secant Modulus: | 2204 | 2200 | 2200 | 2214 | 2165 | 2221 | 2172 |
| MD (psi) | | | | | | | |
| Interlayer Adhesion | 58/58 | 58/58 | 58/58 | 58/58 | 58/58 | 58/58 | |
| X-hatch | | | | | | | |
| Dimensional | −1.3 | −1.8 | −1.7 | −1.8 | −2.6 | −1.2 | −0.6 |
| Stability-MD | | | | | | | |
| Dimensional | −0.9 | −0.7 | −0.7 | −0.8 | −0.6 | −0.6 | −0.6 |
| Stability-TD | | | | | | | |
| Exposed Side | 32 | 32 | 32 | 32 | 32 | 32 | 42 |
| Surface Energy | | | | | | | |
| Adhesion to PSA | 0.1 | | | | 0.1 | | 3.6 |
| (lb/in)*** | | | | | | | |
| Roll Build | | | | | Good (No | Good (No | |
| | | | | | blocking) | blocking) | |

The samples showed a UVT @ 365 nm that was greater than 3, the desired level, as shown in TABLE 6. There was also a high level of haze, as shown in TABLE 6, resulting from roughness on the EVA surface. The trial did not identify any difference in initial interlayer adhesion between the samples made with and without Fusabond added to the EVA.

### Example 3. Three-Layer TPU/EVA/TPU Surface Protection Film

The high initial haze found in Example 2 was addressed by changing the layer configuration to an asymmetric film, with outer TPU layers and a core middle layer of EVA. A first three-layer prototype sample run was prepared as described above in the general procedure. Three samples were prepared as shown in TABLE 7 below. An asymmetric three-layer TPU/EVA/TPU film was prepared with EVA-33 (6 mil total thickness) using KRYSTALGRAN® PN23-200 as the lower layer (3 mil thickness), a layer of ATEVA-3325A (EVA-33) as a middle layer (2 mil thickness), and KRYSTALGRAN® PN23-200 as the top layer (1 mil). (49710 J28836)

TABLE 7

| Test | Method | EVA-33 | EVA-28 | TPU Control |
|---|---|---|---|---|
| EVA Thickness | Internal TM | 30 | 30 | 0 |
| Actual (%) | | | | |
| Small Gels 18″ × | Internal TM | 103 | 25 | 3 |
| Width (Count) | | | | |
| Large Gels 18″ × | Internal TM | 3 | 0 | 1 |
| Width (Count) | | | | |
| Color - Initial YI | Internal TM | 0.85 | 0.63 | 0.61 |
| UVT at 365 nm (%) | Internal TM | 1.8 | 1.8 | 2.2 |
| Gloss (60 Degrees) | Internal TM | 94 | 94 | 93 |
| Haze (%) | Internal TM | 0.8 | 0.8 | 0.9 |
| Light | Internal TM | 93 | 93 | 93 |
| Transmission (%) | | | | |
| Peel Force (g) | Internal TM | 16 | — | — |
| Ultimate Tensile | ASTM D882 | 7217 | 7003 | 9174 |
| MD (psi) | | | | |
| Ultimate Tensile | ASTM D882 | 7156 | 6605 | 9391 |
| TD (psi) | | | | |
| Ultimate Elongation | ASTM D882 | 501 | 501 | 501 |
| MD (%) | | | | |
| Ultimate Tensile | ASTM D882 | 489 | 490 | 527 |
| TD (%) | | | | |
| Modulus at 100% | ASTM D882 | 1301 | 1334 | 1301 |
| MD (psi) | | | | |
| Modulus at 100% | ASTM D882 | 1321 | 1278 | 1321 |
| TD (psi) | | | | |
| Modulus at 50% | ASTM D882 | 935 | 964 | 935 |
| MD (psi) | | | | |
| Modulus at 50% | ASTM D882 | 947 | 921 | 947 |
| TD (psi) | | | | |
| Secant Modulus 5% | Internal TM | 3243 | 3543 | 3270 |
| MD (psi) | | | | |
| Secant Modulus 5% | Internal TM | 3243 | 3543 | 3262 |
| TD (psi) | | | | |
| Interlayer Adhesion | ASTM D3369 | 5B | 5B | — |
| Gravelometer | ASTM D3170 | 8.5 A | 8B | 7A/7B |
| Dimensional Stability | Internal TM | −1.25 | −1 | −0.4 |
| MD (%) | | | | |
| Dimensional Stability | Internal TM | −0.85 | −0.7 | −0.4 |
| MD (%) | | | | |

An asymmetric three-layer TPU/EVA/TPU film was prepared with EVA-28 (6 mil total thickness) using KRYSTALGRAN® PN23-200 as the lower layer (3 mil thickness), a layer of ATEVA-2861A (EVA-28) as a middle layer (2 mil thickness), and KRYSTALGRAN® PN23-200 as the top layer (1 mil). (49710 J28837). For the three-layer TPU/EVA/TPU examples, a 3-layer coextrusion feedblock was used to extrude the multi-layer structure with TPU as the two outer layers and EVA as the center layer. The feedblock was configured such that the thickest (6 mil) TPU layer was formed adjacent to the carrier layer. The three coextruded asymmetric TPU/EVA/TPU resin compositions were extruded onto a PET carrier layer, MT44, Mitsubishi (0.002″×68″), under the conditions shown below in TABLE 8.

TABLE 8
Co-Extrusion Conditions.

| | | Temp (F.) |
|---|---|---|
| Ext #1 | EVA (Middle) | 320 |
| Ext #2 | EVA (Bulk) | 340 |
| Ext #3 | EVA (Skin) | 350 |
| Feedblock | | 320-340 |
| Die | | 340 |

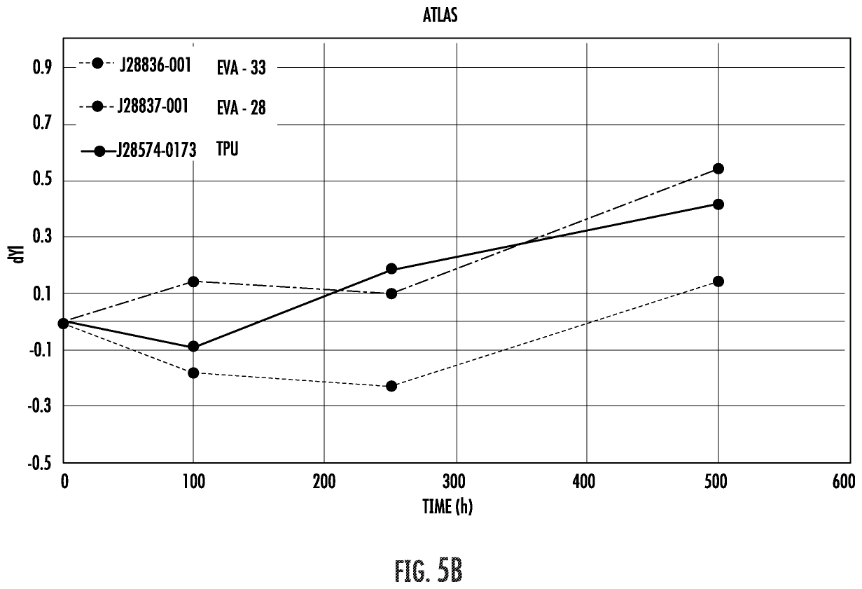

A single layer TPU control film was prepared as a control under general conditions described herein. (49320 J2574). The EVA and TPU percent compositions are shown in TABLE 7 as well as the optical properties and mechanical properties of the films. As also shown in TABLE 7, EVA-33 yielded a 5% secant modulus similar to pure TPU, while EVA-28 was slightly higher/stiffer. The asymmetric design addressed processing concerns from the prior three-layer trial (Example 2). There were no issues with sticking to the lip and the initial haze was <1%. 3-EVA-28-1 resolved the flow defects completely and had a fairly low gel level. The material produced with EVA-28 would be acceptable for standard production. The thicker TPU layer had the opposite pattern, but the TPU skin layer was consistently 1 mil. As shown in FIG. 4, the UV transmission profile for the asymmetric three-layer samples was very similar to the TPU control with just slightly more blocking. TABLE 9 illustrates a summary of hysteresis testing performed on the TPU/EVA/TPU films prepared in Example 3. FIGS. 5A and 5B show the results of an accelerated aging evaluation of the films prepared in Example 3 as compared with TPU control film 49320 J2574.

TABLE 9
10% Hysteresis Testing Summary

| | | | Strain After | Strain After | Strain After | |
|---|---|---|---|---|---|---|
| | | | Pull (MD) | Pull (MD) | Pull (MD) | |
| | Sample | Description | 1 | 2 | 3 | lb Force |
| 1^{st} Product | LR02465-02 | 33% 3325 | 2.9 | 2.6 | 3.9 | 2.1 |
| Trial | | EVA | | | | |
| 1^{st} Product | LR02465-03 | 33% 3325 | 2.9 | 3.6 | 3.9 | 2 |
| Trial | | EVA | | | | |
| 1^{st} Product | LR02465-06 | 33% 3325 | 2.9 | 3.9 | 3.9 | 2.1 |
| Trial | | EVA | | | | |
| 1^{st} Product | LR02465-07 | 49510 | 3.2 | 4.1 | 4.1 | 2.2 |
| Trial | | Control | | | | |
| Prior Data | 49410 | | 2.3 | 3 | 3.3 | 2.2 |
| Prior Data | 49410 | | 2.5 | 3 | 3.3 | 3.5 |
| Prior Data | 49410 | | 3.6 | 4.2 | 4.5 | 2.5 |
| 2^{nd} Product | LR00020-01 | 33% 3325 | 1.6 | 2.1 | 2.3 | 2 |
| Trial | | EVA | | | | |
| 2^{nd} Product | LR00020-02 | 33% 3325 | 1.2 | 1.7 | 1.9 | 2.2 |
| Trial | | EVA | | | | |
| 2^{nd} Product | LR00020-03 | 49320 | 1.9 | 2.5 | 2.7 | 2 |
| Trial | | Control | | | | |

### Example 4. Comparative Examples—Two-layer TPU/PVDF-PMMA and Two-Layer TPU Films

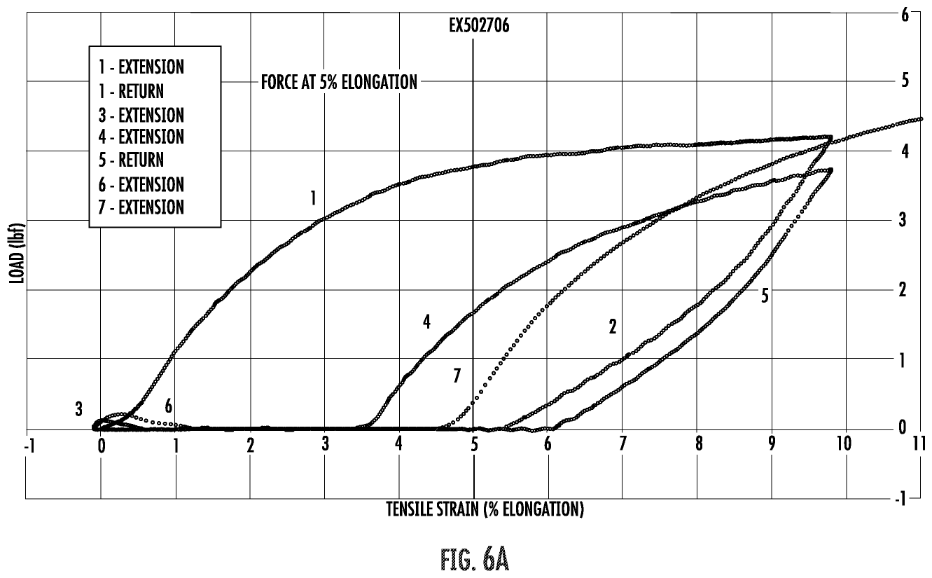

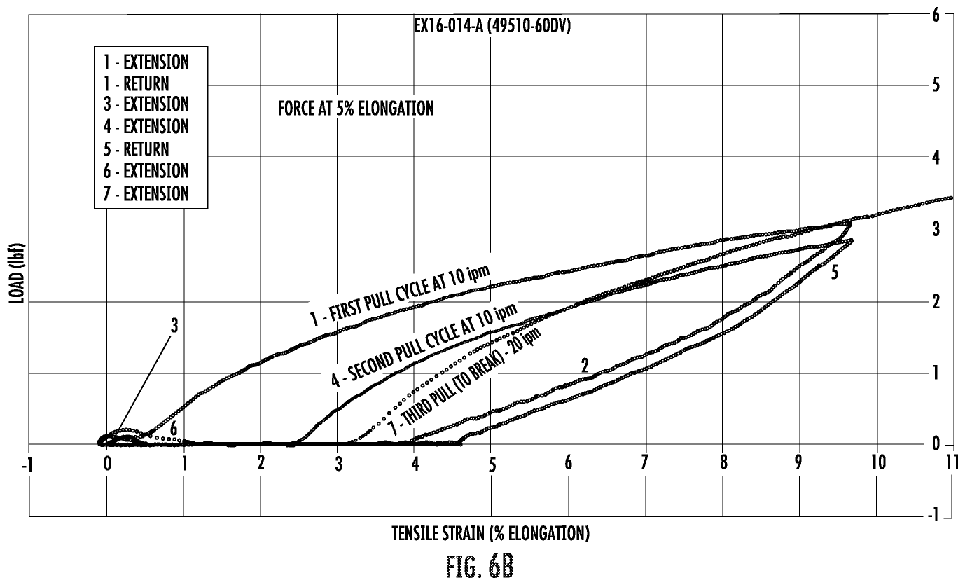

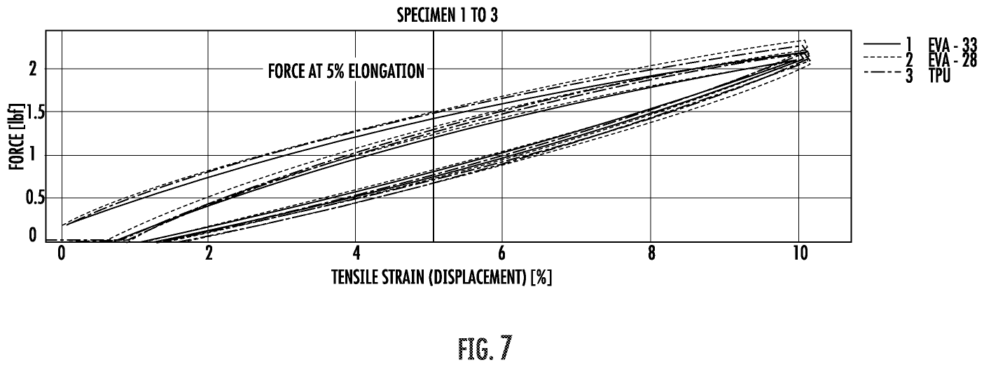

Referring now to FIGS. 6A and 6B, hysteresis curves for multi-layer films are shown, as compared to FIG. 7, hysteresis curves for the three-layer TPU/EVA/TPU films (EVA-33 and EVA-28) and the TPU film prepared in Example 3. FIG. 6A shows the hysteresis curve for a two-layer TPU/PVDF-PMMA film. The hysteresis curve of the two-layer TPU/PVDF-PMMA film shows high force at 5% elongation (˜4 lbs).

FIG. 6B shows the hysteresis curve for a two-layer TPU film. The hysteresis curve of the two-layer TPU film 49510-60DV shows the “high end” currently accepted by industry-force at 5% elongation (˜2.2 lbs).

FIG. 7 shows the hysteresis curve for the asymmetric three-layer EVA/TPU/TPU films, with EVA-33 and EVA-22 prepared in Example 3, as compared to the hysteresis curve for monolayer TPU. The hysteresis curves for three-layer EVA/TPU/TPU films prepared with EVA-33 and EVA-22 show acceptable force at 5% elongation (˜ 1.5 lbs)—at or below the force at 5% elongation for monolayer TPU, an accepted industry standard.

Installation trials showed that the TPU/PVDF-PMMA film was too stiff to effectively install. The two layer 49510-60DV was the stiffest that would be acceptable in the industry. Based on these results, a target maximum for 5% secant modulus (a calculated value proportional to the raw force shown above) was established. Additionally, the hysteresis test shown in FIG. 6A demonstrates that there is higher residual strain on the PVDF-PMMA containing film.

While the devices, systems and methods have been described in detail herein in accordance with certain preferred embodiments thereof, many modifications and changes therein may be effected by those skilled in the art. Accordingly, the foregoing description should not be construed to be limited thereby but should be construed to include such aforementioned obvious variations and be limited only by the spirit and scope of the following claims.

For example, in a first aspect, a first embodiment is a film comprising first and second thermoplastic polyurethane layers and an ethylene vinyl acetate layer positioned between the first and second thermoplastic polyurethane layers.

A second embodiment is the first embodiment, wherein the first thermoplastic polyurethane layer has a first thickness, the second thermoplastic polyurethane layer has a second thickness, and the ethylene vinyl acetate layer has a third thickness, wherein at least one of the first, second, and third thicknesses is different from the other thicknesses.

A 3^{rd} embodiment is any combination of the first 2 embodiments, wherein the film has a total thickness and the ethylene vinyl acetate (EVA) layer has a thickness of about 20% to about 70% of the total thickness.

A 4^{th} embodiment is any combination of the first 3 embodiments, wherein the EVA layer thickness is about 20% to about 55% of the total thickness.

A 5^{th} embodiment is any combination of the first 4 embodiments, wherein the EVA layer thickness is about 30% to about 35% of the total thickness.

A 6^{th} embodiment is any combination of the first 5 embodiments, wherein the EVA layer thickness is about 33% of the total thickness.

A 7^{th} embodiment is any combination of the first 6 embodiments, wherein the ethylene vinyl acetate layer has a thickness of between about 2 mil to about 4 mil.

An 8^{th} embodiment is any combination of the first 7 embodiments, wherein the first and second thermoplastic layers have a different thickness.

A 9^{th} embodiment is any combination of the first 8 embodiments, wherein the first thermoplastic layer has a thickness of about 1 mil, and the second thermoplastic layer has a thickness of between about 1 mil to about 3 mil.

A 10^{th} embodiment is any combination of the first 9 embodiments, wherein a thickness of the first thermoplastic layer is less than a thickness of the second thermoplastic layer, and a thickness of the intermediate ethylene vinyl acetate layer is greater than the thickness of the first thermoplastic layer.

An 11^{th} embodiment is any combination of the first 10 embodiments, wherein the first thermoplastic layer has a thickness of about 1 mil, the second thermoplastic layer has a thickness of between about 3 mil, and the ethylene vinyl acetate layer has a thickness of between about 2 mil.

A 12^{th} embodiment is any combination of the first 10 embodiments, wherein the ethylene vinyl acetate layer comprises a thermoplastic ethylene vinyl acetate copolymer having a vinyl acetate proportion in the co-polymer of between about 28% to about 33%.

A 13^{th} embodiment is any combination of the first 12 embodiments, wherein the first and second thermoplastic polyurethane layers comprise an aliphatic thermoplastic polyurethane.

A 14^{th} embodiment is any combination of the first 13 embodiments, wherein the film has a 5% secant modulus below about 5000 psi.

A 15^{th} embodiment is any combination of the first 14 embodiments, further comprising a carrier layer.

A 16^{th} embodiment is any combination of the first 15 embodiments, herein the carrier layer comprises polyethylene terephalate (PET).

A 17^{th} embodiment is any combination of the first 16 embodiments, further comprising a pressure sensitive adhesive layer, wherein the first thermoplastic polyurethane layer is adhered to the pressure sensitive adhesive layer and a topcoat positioned on the second thermoplastic polyurethane layer.

A 18^{th} embodiment is any combination of the first 17 embodiments, further comprising a release layer positioned on an outer surface of the pressure sensitive adhesive layer.

In another aspect, a window is provided comprising the film of any of the above 18 embodiments.

In another aspect, an exterior part for a vehicle is provided comprising the film of any of the above 18 embodiments.

In another aspect, a turbine blade is provided comprising the film of any of the above 18 embodiments.

In another aspect, an electronic display is provided comprising the film of any of the above 18 embodiments.

In another aspect, a protective coating for a surface comprising first and second thermoplastic polyurethane layers and an ethylene vinyl acetate layer positioned between the first and second thermoplastic polyurethane layers. The protective coating has a 5% secant modulus less than about 5000 psi.

A second embodiment is the first embodiment, wherein the 5% secant modulus is less than about 3600 psi.

A third embodiment is any combination of the first 2 embodiments, wherein the coating has a chipping rating of 8.5 A as measured by a gravelometer according to ASTM D3170.

An 4^{th} embodiment is any combination of the first 3 embodiments, wherein the coating has an ultimate elongation MD of about 450% to about 550%.

A 5^{th} embodiment is any combination of the first 4 embodiments, wherein the ultimate elongation MD is about 500%.

A 6^{th} embodiment is any combination of the first 5 embodiments, wherein the coating has a light transmission of at least about 93%.

A 7^{th} embodiment is any combination of the first 6 embodiments, wherein the coating has a total thickness and the ethylene vinyl acetate (EVA) layer has a thickness of about 20% to about 70% of the total thickness.

An 8^{th} embodiment is any combination of the first 7 embodiments, wherein the EVA layer thickness is about 20% to about 55% of the total thickness.

A 9^{th} embodiment is any combination of the first 8 embodiments, wherein the EVA layer thickness is about 30% to about 35% of the total thickness.

A 10^{th} embodiment is any combination of the first 9 embodiments, wherein the EVA layer thickness is about 33% of the total thickness.

An 11^{th} embodiment is any combination of the first 10 embodiments, further comprising a pressure sensitive adhesive layer configured to be adhered to the surface.

A 12^{th} embodiment is any combination of the first 11 embodiments, further comprising a carrier layer positioned on the second thermoplastic polyurethane layer.

A 13^{th} embodiment is any combination of the first 12 embodiments, wherein the surface is a painted surface.

A 14^{th} embodiment is any combination of the first 13 embodiments, wherein the painted surface is an automobile.

In another aspect, a first embodiment is a method of making a surface protective film comprising providing first and second polymer resins comprising a thermoplastic polyurethane, providing an ethylene vinyl acetate resin comprising a thermoplastic ethylene vinyl acetate copolymer and co-extruding the first and second polymer resins and the ethylene vinyl acetate resin to form a surface protection film comprising first and second thermoplastic polyurethane layers, and an ethylene vinyl acetate layer positioned between the first and second thermoplastic polyurethane layers.

A second embodiment is the first embodiment, further comprising providing a carrier layer and co-extruding the first and second polymer resins and the ethylene vinyl acetate resin onto the carrier layer.

A 3^{rd} embodiment is any combination of the first 2 embodiments, wherein the first thermoplastic polyurethane layer has a first thickness, the second thermoplastic polyurethane layer has a second thickness, and the intermediate ethylene vinyl acetate layer has a third thickness, wherein at least one of the first, second, and third thicknesses is different from the other thicknesses.

A 4^{th} embodiment is any combination of the first 3 embodiments, wherein the first and second thermoplastic polyurethane layers and the intermediate ethylene vinyl acetate layer each have a thickness, and the thickness of the first thermoplastic layer is less than the thickness of the second thermoplastic layer, and the thickness of the intermediate ethylene vinyl acetate layer is greater than the thickness of the first thermoplastic layer.

A 5^{th} embodiment is any combination of the first 4 embodiments, wherein the second thermoplastic layer is co-extruded adjacent to the carrier layer.

A 6^{th} embodiment is any combination of the first 5 embodiments, wherein the surface protection film has a total thickness and the ethylene vinyl acetate (EVA) layer has a thickness of about 20% to about 70% of the total thickness.

A 7^{th} embodiment is any combination of the first 6 embodiments, wherein the EVA layer thickness is about 20% to about 55% of the total thickness.

An 8^{th} embodiment is any combination of the first 7 embodiments, wherein the EVA layer thickness is about 30% to about 35% of the total thickness.

A 9^{th} embodiment is any combination of the first 8 embodiments, wherein the EVA layer thickness is about 33% of the total thickness.

What is claimed is:

1. A film comprising:
first and second thermoplastic polyurethane (TPU) layers; and
an ethylene vinyl acetate (EVA) layer positioned between the first and second thermoplastic polyurethane layers.

2. The film of claim 1, wherein the first TPU layer has a first thickness, the second TPU layer has a second thickness, and the EVA layer has a third thickness, wherein at least one of the first, second, and third thicknesses is different from the other thicknesses.

3. The film of claim 1, wherein the film has a total thickness and the EVA layer has a thickness of about 20% to about 70% of the total thickness.

4. The film of claim 3, wherein the EVA layer thickness is about 20% to about 55% of the total thickness.

5. The film of claim 3, wherein the EVA layer thickness is about 30% to about 35% of the total thickness.

6. The film of claim 1, wherein the EVA layer has a thickness of between about 2 mil to about 4 mil.

7. The film of claim 1, wherein the first TPU layer has a thickness of about 1 mil, and the second TPU layer has a thickness of between about 1 mil to about 3 mil.

8. The film of claim 1, wherein the EVA layer comprises a thermoplastic ethylene vinyl acetate copolymer having a vinyl acetate proportion in the co-polymer of between about 28% to about 33%.

9. The film of claim 1, wherein the film has a 5% secant modulus below about 5000 psi.

10. The film of claim 1, further comprising a carrier layer comprising polyethylene terephalate (PET).

11. A protective coating for a surface comprising:
first and second thermoplastic polyurethane (TPU) layers;
an ethylene vinyl acetate (EVA) layer positioned between the first and second TPU layers; and
wherein the protective coating has a 5% secant modulus less than about 5000 psi.

12. The coating of claim 11, wherein the 5% secant modulus is less than about 3600 psi.

13. The coating of claim 11, wherein the coating has a chipping rating of 8.5 A as measured by a gravelometer according to ASTM D3170.

14. The coating of claim 11, wherein the coating has an ultimate elongation MD of about 450% to about 550%.

15. The coating of claim 11, wherein the coating has a light transmission of at least about 93%.

16. The coating of claim 11, wherein the coating has a total thickness and the EVA layer has a thickness of about 20% to about 70% of the total thickness.

17. A method of making a surface protective film comprising:
providing first and second polymer resins comprising a thermoplastic polyurethane (TPU);
providing an ethylene vinyl acetate (EVA) resin comprising a thermoplastic ethylene vinyl acetate copolymer; and
co-extruding the first and second polymer resins and the ethylene vinyl acetate resin to form a surface protection film comprising first and second TPU layers, and an EVA layer positioned between the first and second TPU layers.

18. The method of claim 17, further comprising providing a carrier layer and co-extruding the first and second polymer resins and the ethylene vinyl acetate resin onto the carrier layer.

19. The method of claim 17, wherein the first TPU layer has a first thickness, the second TPU layer has a second thickness, and the EVA layer has a third thickness, wherein at least one of the first, second, and third thicknesses is different from the other thicknesses.

20. The method of claim 17, wherein the surface protection film has a total thickness and the EVA layer has a thickness of about 20% to about 70% of the total thickness.
